(19) United States
(12) Patent Application Publication
(10) Pub. No.: US 2004/0257999 A1
(43) Pub. Date: Dec. 23, 2004

(54) Method and system for detecting and disabling sources of network packet flooding

(76) Inventor: Gary MacIsaac, Vancouver (CA)

Correspondence Address: KLARQUIST SPARKMAN, LLP, 121 SW SALMON STREET, SUITE 1600, PORTLAND, OR, 97204, US

(21) Appl. No.: 10/495,325

(22) PCT Filed: Nov. 16, 2001
(86) PCT No.: PCT/CA01/01602

(51) Int. Cl. H04L 12/28; H04L 12/56

(52) U.S. Cl. 370/252; 370/389

(57) ABSTRACT

A system and method of analyzing data traffic associated with messages being sent through a communications network is provided. The method comprises receiving data traffic, obtaining characteristics of data traffic and identifying packet flooding by analyzing the characteristics. The system and method may analyze the data traffic to determine whether the data traffic is not bursty. The system and method may also correlate characteristics of the data traffic to a Hurst parameter. The system and method may respond to packet flooding by terminating a connection associated with data traffic. Denial of service attacks can be prevented by analyzing statistics regarding the network data traffic.

### CROSS-REFERENCE TO RELATED APPLICATIONS

The benefit of the filing date of Canadian patent application No. 2,326,252 filed 17 Nov. 2000 is claimed herein.

### TECHNICAL FIELD

This invention relates generally to computer networks and security, and more particularly to a system and method for detecting the source and halting the progress of network packet flooding. In some applications the invention may be embodied in network-connected devices such as routers and switches.

### BACKGROUND

The rapid expansion of high-speed personal Internet connections and the use of the World Wide Web for commerce, entertainment and education provides significant benefits to the global user community. The wide-spread, low cost and continuous availability of web-based information services has spawned developments ranging from new business models to portals which provide access to government and education services, to the rapid and free exchange of ideas and information for all members of the Internet community.

Because the Internet is so widely available to the public it is vulnerable to being disrupted by various malicious exploits of network protocol behaviors which are fundamental to the operation of the Internet. The malicious exploits include the creation and dissemination of rapidly propagating computer viruses which target particular operating systems or applications; abuses of network protocol features such as packet broadcasting and TCP/IP connection establishment; and intrusions into network-connected computer systems.

The perpetrators of such malicious exploits often take advantage of computer operating system flaws and basic human errors in system configuration such as poor choices for access control passwords. System administrators and users can attempt to minimize the vulnerabilities of their computer systems by changing procedures (e.g. using stronger passwords), applying software patches, and the like. Keeping computer systems secure is an ongoing task. It is inevitable that software bugs will continue to appear, user configuration errors will be made and attackers will uncover previously unknown weaknesses in systems or will modify current attack software in new ways.

Even a computer system that is completely secure is vulnerable to having its Internet connectivity attacked. One class of malicious Internet activity, which can produce significant disruption to users of Internet web sites and critical networked devices such as core routers, includes so-called “distributed denial of service” (“DDOS”) attacks or “packet flooding”. Such attacks are very difficult to defend against because they make use of functions which are fundamental to the operation of the internet itself.

DDOS attacks are characterized by the compromise of many different computer systems, often scattered across the Internet, along with the installation of drone software agents on the compromised computers. The compromised attacking systems may number in the tens, hundreds or even thousands of computers. The drone software agents cause each of the compromised computers to launch a coordinated flood of packets. The packets are all addressed to a selected target system. The packets may comprise, for example, continuous streams of Transmission Control Protocol (TCP), User Datagram Protocol (UDP) and/or Internet Control Message Protocol (ICMP) packets all directed at the target system. These protocols are implemented at the Internet layer and the transport layer which are described in Internet Engineering Task Force (“IETF”) RFC Standard 1122 and related RFC documents.

Dealing with the incoming packets generated by the compromised computer system consumes so much of the resources of the target computer system that it is incapable of servicing normal requests. Often a denial of service attack of this type can last for an extended period making a target server unavailable for the duration of the attack. Further, the flood of packets all addressed to a target system can overload the packet processing capability of routers located near the target system. Thus a distributed denial of service attack can affect users of computer systems which are not directly targeted by the attack.

DDOS attacks are very difficult to trace to their source. In almost all cases, the source Internet Protocol (IP) addresses found in the flooding packets have been spoofed, that is altered to a false value, thereby providing no information about the true identity of the originating systems.

A detailed description of the software agents used in distributed denial of service attacks can be found at the Computer Emergency Response Team web site operated by the Carnegie-Mellon University Software Engineering Institute, “CERT Advisory CA-2000-01 Denial-of-Service Developments”.

There exist some systems which may provide some means for identifying signatures of known drone agents and/or limiting the ability of drones to spoof the source address of packets used in attacks. Packet filtering firewalls such as described, for example, in U.S. Pat. No. 5,606,668 issued Feb. 25, 1997 and entitled System for securing inbound and outbound data packet flow in a computer network can be used to block certain packets before they reach a particular computer or network. A packet filtering firewall inspects the contents of the header of each packet received at the firewall and applies a set of rules to determine what should be done with the packet. As more rules are applied to the firewall, performance suffers and firewall maintenance increases. A packet filtering firewall does not provide an effective defense against a DDOS attack because the firewall itself can become overwhelmed by the incoming packets.

Intrusion detection systems can be used to determine when a computer system is being compromised. U.S. Pat. No. 6,088,804 entitled Adaptive system and method for responding to computer network security attacks describes one such system which uses agents and adaptive neural network technology to learn simulated attack signatures (e.g. virus patterns). A disadvantage of this system is that real attack signatures may not be similar to the simulated signatures and new signatures for which no training has been carried out may go completely undetected. Another system described in U.S. Pat. No. 5,892,903 entitled Method and apparatus for detecting and identifying security vulnerabilities in an open network computer communication system tests computers and network components for known vulnerabilities and provides reports for action by network management staff. However, this system requires a database of known vulnerabilities and detailed computer-system-specific descriptions of vulnerable components. Furthermore, these prior art system implementations depend upon operating system specific and packet content specific information to identify attack signatures on compromised computers.

There will always be Internet computer systems which are vulnerable to being compromised and which can be used to launch DDOS attacks against other computer systems. In this constantly evolving environment, intrusion detection systems will naturally lag in detection capabilities. Encryption techniques and other stealth methods are routinely used by attack perpetrators to avoid detection of drone agents and the interception of communications between the malicious user, the master agents and the drone agents.

There is currently no easy method to discover the path from the target of an attack to the sources of the attack. Locating the source systems is a time-consuming process involving the detailed examination of system and router logs, decoding of drone agent binary code, and extensive human communication among the affected parties to exchange evidence.

Thus, there is a need for a system and method which can quickly detect the onset of packet flooding. There is a particular need for such a system and method capable of disabling the source of the packet flood, in an automatic or user controlled manner, which is independent of the operating system used by the attacking computer or the target computer and independent of the upper layer network protocols used to mount the attack.

### SUMMARY OF THE INVENTION

This invention relates to methods and systems for detecting packet flooding in a data communication network. In a first aspect, the invention provides a method of detecting the onset of packet flooding by analyzing data traffic associated with messages being sent through a communication network. The method comprises receiving data traffic, obtaining characteristics of data traffic and identifying packet flooding by analyzing the characteristics.

The method may analyze the data traffic to determine whether the data traffic is bursty or not. The method may derive a burstiness measure such as a Hurst parameter from the characteristics. The method may respond to the packet flooding by terminating a connection associated with data traffic. The method may also respond to packet flooding by generating an alarm condition.

A second aspect of the invention provides a system for analyzing data traffic associated with messages being sent from an originating node to a destination node. The messages are sent through a communication network to the destination node. The system comprises a connection to the network for receiving data traffic, a computer connected to the connection for analyzing the data traffic and analysis means associated with the computer for obtaining characteristics of the data traffic. The analysis means may identify packet flooding by analyzing the characteristics. The system may utilize data associated with a Hurst parameter. The system may have means for terminating a communication link between the originating node and the destination node. Alternatively, or additionally, the system may generate an alarm condition.

Some specific aspects of the invention provide a method for detecting packet flooding in a communication network comprising a data link carrying data traffic which includes obtaining a burstiness characteristic and comparing the burstiness characteristic to a burstiness threshold. In some embodiments a packet flooding condition is detected based on both a burstiness characteristic and a utilization. In such cases the method may comprise comparing the utilization to a utilization threshold.

Another aspect of the invention provides systems for detecting packet flooding in communication networks which comprise a data link carrying data traffic. Such systems comprise an interface for receiving information about the data traffic; an analysis mechanism configured to provide a measure of burstiness in the data traffic from the information; and, a packet flooding detection mechanism configured to signal a packet flooding condition based at least in part on the measure of burstiness. The analysis mechanism may comprise a data processor executing software instructions which cause the data processor to compute the measure of burstiness based upon the information.

Yet another aspect of the invention provides a program product comprising a medium carrying a set of computer-readable signals containing instructions which, when executed by a computer processor, cause the computer processor to perform a method according to the invention.

Further aspects which may be present individually or in various combinations in some specific embodiments of the invention are described below.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings:

FIG. 1 is a diagram of a computer network including a packet flooding detector according to an embodiment of the present invention;

FIG. 2 is a block diagram of the packet flooding detector associated with the embodiment of FIG. 1;

FIG. 3 is a block diagram of the method and process implemented by one embodiment of apparatus according to FIG. 1;

FIG. 4 is a flow diagram of the method and process implemented by one possible embodiment of apparatus according to FIG. 1 to detect and disable a packet flood source;

FIG. 5 is a further flow diagram illustrating the method and process used by one possible embodiment of apparatus according to FIG. 1 to detect and disable a packet flood source;

FIG. 6 is a diagram showing a possible organization of network traffic parameters in vectors \vec{U} and \vec{H} for use in monitoring the burstiness and utilization of traffic on a link; and,

FIG. 7 is a block diagram showing functional aspects of a packet flooding detector according to an embodiment of the invention.

### DESCRIPTION

Throughout the following description, specific details are set forth in order to provide a more thorough understanding of the invention. However, the invention may be practiced without these particulars. These particulars are provided for the purpose of explanation, and not limitation, of the invention. In other instances, well known elements have not been shown or described in detail to avoid unnecessarily obscuring the invention. Accordingly, the specification and drawings are to be regarded in an illustrative, rather than a restrictive, sense. In the drawings, like elements feature like reference numerals and individual elements bear unique alphabetical suffixes.

This invention monitors the burstiness of network traffic and detects the onset of packet flooding by detecting abnormal changes in the burstiness of the traffic. A Hurst parameter may be used as a measure of burstiness. The packets generated by a packet flooding attack are more uniform than packets that can be expected in normal operation. Such packets tend to exhibit relatively constant packet counts and octet counts and to produce high levels of utilization on the data links they are traversing. On a data link which is carrying packets which have been generated as part of a packet flooding attack the burstiness will be lower than expected. Where the burstiness is measured using a Hurst parameter the effect of an injected attack traffic stream is to reduce the value of the Hurst parameter from that observed under normal traffic patterns during high levels of utilization.

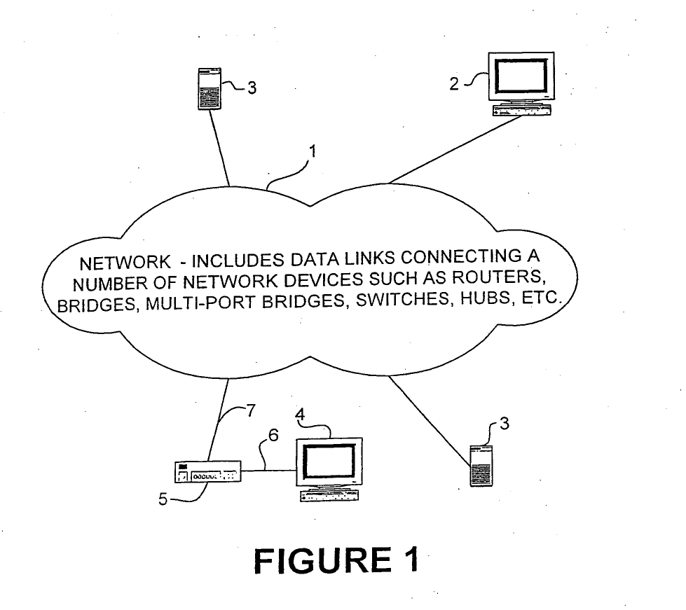

FIG. 1 shows a data communication network 1 which comprises a number of networked devices interconnected by data links. The networked devices may be organized into sub-networks and may include, but are not limited to, routers, bridges, multi-port bridges (ethernet switches), hubs, ATM switches, servers 3 and client workstations 2, 4. Network 1 may be local to a site thereby representing a Local Area Network (LAN) or may be interconnected on a global scale as is the Internet.

To understand the operation of the invention it is necessary to understand some things about packet traffic patterns on a data communication network. During the normal operation of network 1 the networked devices communicate with one another. For example, a client computer 2 may communicate with a plurality of server computers 3 or other client computers connected to network 1. In all cases, communication between networked devices involves the use of several protocols. These protocols may be classified, for example, according to the OSI 7-layer model of network protocols. The protocols may include protocols from the TCP/IP protocol suite.

A typical interaction between a client computer and a server computer such as a World Wide Web server involves the client 2 initiating a protocol connection with a server 3. This is followed by a number of packet transfers between the client system 2 and the server system 3. Eventually the protocol connection is terminated by either the client or the server. A plurality of such connections between a plurality of clients and a plurality of servers results in an aggregation of packet transfers on the network. A detailed description of this process for the TCP/IP protocol suite is found in Stallings High-speed Networks: TCP/IP and ATM Design Principles, Prentice-Hall, 1998, which is incorporated herein by reference.

A characteristic of traffic on networks in which devices exchange data by establishing protocol connections with one another is that packets are transmitted in bursts onto the network. Measurements of the patterns of these bursts of packets have shown them to be fractal or self-similar in nature. That is, the pattern of packet arrivals at a particular measurement point on the network, for a given sample, observed at different time scales is similar at each of these time scales. For example, if a large burst of packets is observed between time t and time t+1, and if 100 sub-samples are extracted over this interval a similar pattern of packet bursts within each of the sub-samples would be seen.

There is now a substantial body of research work which has demonstrated the bursty character of Ethernet data transmissions. Some of this work is described in: M. E. Crovella et al., Self-Similarity in World Wide Web Traffic: Evidence and Possible Causes, IEEE/ACM Transactions on Networking 1997; 5(6): 835-846; and Leland, W. E. et al. On the Self-Similar Nature of Ethernet Traffic (Extended Version), IEEE/ACM Transactions on Networking 1994, 2(1) 1-15 both of which are incorporated herein by reference.

The Hurst parameter H is one way to characterize the self-similarity of observed packet traffic on a network link. The Hurst parameter can range from 0.5 to 1.0. Values of H near 0.5 indicate a short-range dependent process which describes network traffic lacking bursty, self-similar characteristics. Values of H exceeding 0.5 are indicative of long-range dependent processes which describe network traffic of a bursty, self-similar nature.

An estimator of H may be obtained by monitoring traffic at a point in a network. One method of estimating the Hurst parameter is described in international patent application publication No. WO99/40703. Another method of estimating a Hurst parameter is described in Canadian patent application No. 2,276,526.

FIG. 1 shows apparatus according to one embodiment of the invention. A packet flood detection device 5 is interposed between client computer 4 and a server computer 3 (or second client computer 2). Detection device 5 has a first communication link 6 connected to client computer 4 and a second communication link 7 connected to some other networked device in the network 1. In the illustrated embodiment, detection device 5 receives all packets arriving on first link 6 and transmits these packets out the second link 7 and onto the rest of network 1. Likewise, detection device 5 receives all packets arriving on second link 7 and may transmit all but a subset of these packets out the first link 6. The subset of packets received on the second link 7 which are not transmitted to the first link 6 are those packets addressed, using a suitable protocol (including but not limited to the Ethernet link layer and/or TCP/IP protocol suite described in the references cited above), to detection device 5.

Those skilled in the art will understand that detection device 5 may be located anywhere in network 1 where it can sample packets being transmitted between any two networked devices of network 1. For example, detector device 5 may comprise a passive monitoring device which does not participate actively in the transmission of packets on any data link. Packet handling may continue to be done by a router switch or the like.

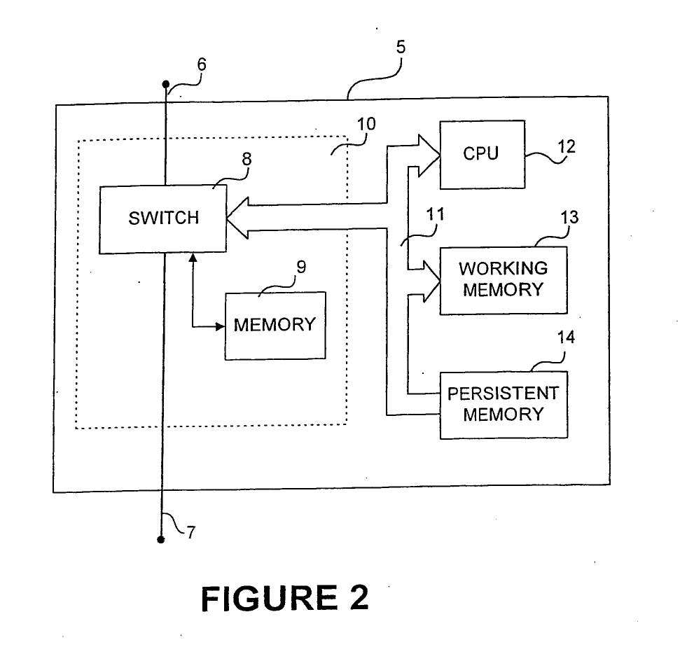

FIG. 2, shows a possible construction of detection device 5 according to the invention. Detection device 5 comprises a switch subsystem 10 containing a switch processor 8. First link 6, second link 7 and a memory 9 are connected to switch processor 8. Memory 9 may comprise a static ram (SRAM), for example. Switch processor 8 may, in one embodiment, comprise a model BCM5304M 10/100 Ethernet switch made by Broadcom Corporation. Other implementations of switches are known in the art.

Switch subsystem 10 is connected to a system bus 11. Detection device 5 includes a CPU 12, working memory 13 and persistent memory 14 which are also connected to the system bus 11. CPU 12 may comprise, for example, a model MCF5407 microprocessor made by Motorola, Inc. Working memory 13 may comprise RAM, for example. Persistent memory 14 may comprise a flash RAM, EPROM, or the like.

CPU 12 of detection device 5 runs a Real-Time Operating System (RTOS), loaded from persistent memory 14. The RTOS may coordinate the operation of switch subsystem 10 and the overall operation of detection-device 5. Those skilled in the art understand how CPU 12 can be programmed to coordinate the operation of detection device 5. The RTOS may implement for example the ISO/IEC Standard 15802-3 [IEEE 802.1D MAC bridge standard] and the IEEE 802.1 Q VLAN standard for communicating with other devices on network 1. Further details on the design and operation of Ethernet switches can be found in: Seifert, Rich The Switch Book: The Complete Guide to LAN Switching Technology John Wiley, New York 2000 which is incorporated herein by reference.

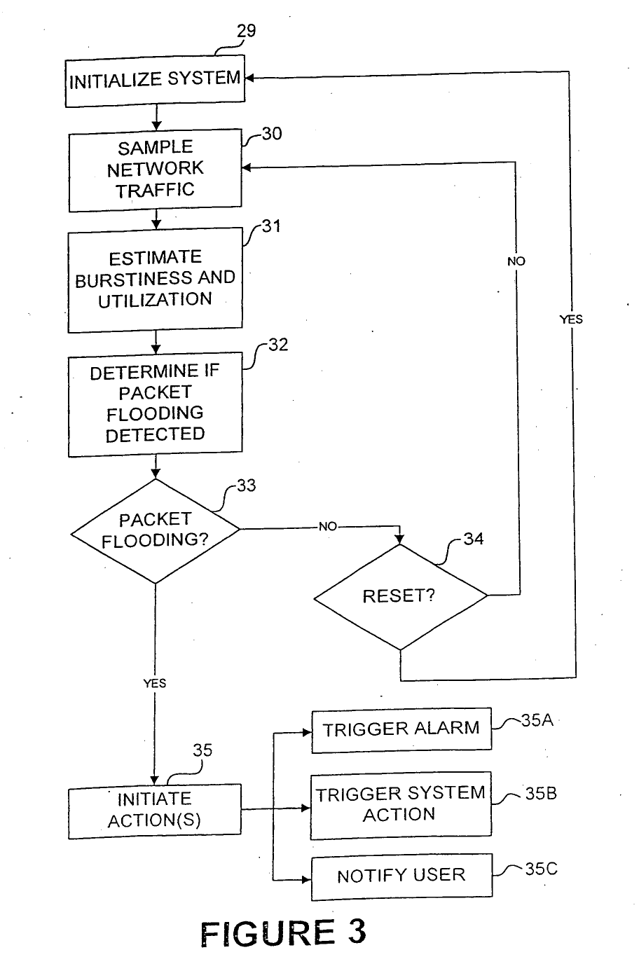

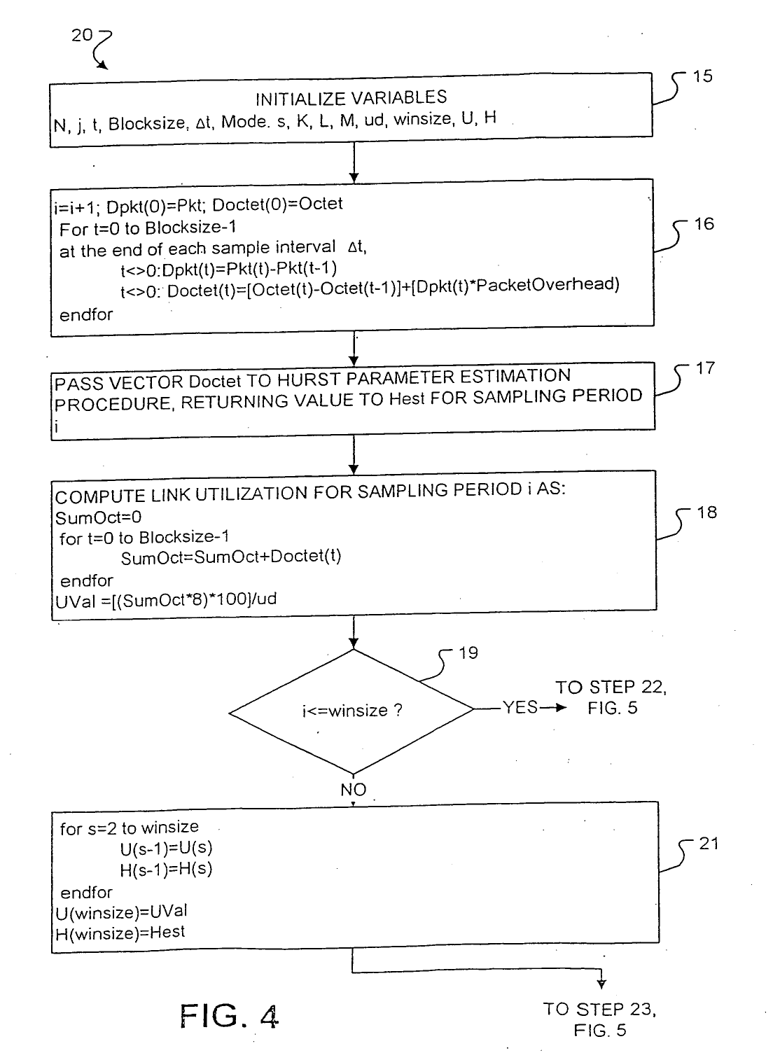

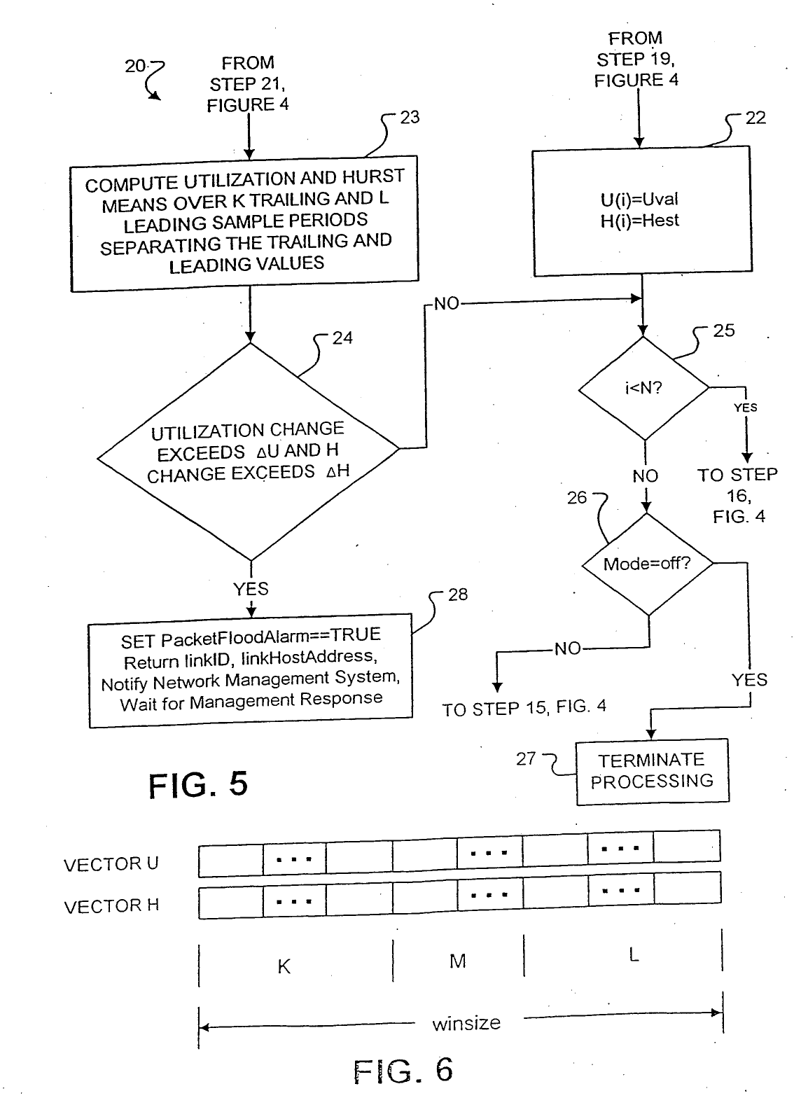

FIG. 3 illustrates a method 20 according to one embodiment of the invention. FIGS. 4 and 5 illustrate one possible specific way to implement the method of FIG. 3. Method 20 may be performed by detection device 5 to detect the onset of a packet flood attack on link 6. Method 20 may comprise a number of steps which are performed in real-time. These steps may be performed by CPU 12 under the control of software instructions. The software instructions may comprise instructions in a process running under the RTOS. The software instructions may be stored in persistent memory 14. CPU 12 uses working memory 13 to store data and instructions during execution.

As shown in FIG. 3, method 20 begins by initializing detection device 5 (block 29). When detection device 5 has been initialized it samples network traffic (block 30), Sampling the network traffic comprises maintaining certain statistical information about the network traffic. When a sample of network traffic has been collected, method 20 uses the compiled statistical information to estimate a measure of the burstiness of the network traffic (block 31). This estimation may comprise computing an estimated Hurst parameter for the network traffic. In block 31 method 20 also determines a network utilization. Based upon the burstiness measure or the burstiness measure and the network utilization, method 20 determines whether packet flooding is occurring (block 32). If so, as indicated by block 33, method 20 proceeds to take one or more actions (block 35). The actions may include triggering an alarm (block 35A), triggering a system action (for example, imposing a packet filtering rule) (block 35B) or notifying a user that packet flooding has been detected (block 35C). If no packet flooding is detected then method 20 continues to sample the network traffic (unless there is an indication that detection device 5 should be reset as indicated by block 34).

FIGS. 4 and 5 illustrate one version of method 20 in more detail. Step 15, initializes detection device 5 by setting a number of parameters to specific values. The parameters include:

N the total number of sample periods this instance of the detection process will observe before reinitializing;

j an exponent of 2 (used to specify Blocksize which is a number of measurements that will be recorded during one sample period. Blocksize may be given by 2^{j});

Dₜ the duration, in milliseconds, of the sampling interval for which a single measurement is recorded;

T total duration, in milliseconds, of one sample period, (T may be given by the product of Blocksize and Dₜ);

ud a denominator used in computing average network utilization during one sample period, (ud may be given by the product of (T/1000) and LinkDataRate;

LinkDataRate the speed of first link 6, in bits per second;

I index for each sample period up to N, I is initialized to 0;

\vec{U} the sampling period window vector for link utilization;

\vec{H} the sampling period window vector for Hurst parameter estimates;

H_{flood} Hurst parameter value below which a packet flood alarm is triggered;

ΔH user-defined change in Hurst estimator representing a deviation from a normal value;

ΔU user-defined change in utilization representing a deviation from a normal value;

winsize window size of sample periods used to compute mean past and present values for the parameter (winsize is initialized to K+M+L);

K the number of consecutive sample periods, starting with the first period, used to compute the mean values \overline{U_{Past}} and \overline{H}_{Past} from the sampling period window vectors \vec{U} and \vec{H}.

M the number of consecutive sample periods used as a transition zone following the first K samples in the sampling period window vectors \vec{U} and \vec{H} from the Past to Present mean computations.

L the number of consecutive sample periods following the K⁺ M samples in the sampling period window used to compute the mean values \overline{U_{Present}} and \overline{H_{Present}} from the sampling period window vectors \vec{U} and \vec{H}.

mode set to “monitor” for collecting packet traffic data on first link 6 and set to “off” when the traffic monitoring process is terminated.

Following initialization in block 29, detection method 20 proceeds to a data acquisition step (block 16 of FIG. 4). In block 16, for each of a number, Blocksize, of time intervals, the number of packets received on link 6 is recorded in vector \vec{D}ₚₖₜ (t) and a volume of data (for example, a number of octets of data) received on link 6 is recorded in vector \vec{D}_{octet}(t). In block 16, t ranges from 0 to Blocksize-1. In the currently preferred embodiments of the invention the packet counts and data volumes are sampled by CPU 12 from statistics registers maintained for first link 6 by switch 8. The statistics registers preferably include a packet count register which contains a value Pkt representing a number of packets received on link 6 and an octet count register which contains a value Octet which represents a number of octets in packets which have been received on link 6. CPU 12 stores these values in a suitable data structure in working memory 13.

At each time step, t, the value of \vec{D}ₚₖₜ (t) is given by the difference between the value of the packet count register, Pkt at time t, minus the value of the packet count register Pkt at time t−1, with the exception that at time t=0 the value of the packet count register is used directly. Similarly, at each time step, t, the value of \vec{D}_{octet}(t) is given by the value of the octet count register, Octet at time t, minus the value of the octet count register Octet at time t−1. At time t=0 the value of the octet count register can be used directly.

Octet may not include overhead associated with each packet and may therefore underestimate the amount of data being carried in link 6. Where this is the case, the value of \vec{D}_{octet}(t) may be corrected to include all data in link 6 by adding to the value of \vec{D}_{octet}(t) the product of the number of packets counted at time t, \vec{D}ₚₖₜ (t) and the number of bits which represent the fixed overhead transported with each packet [PacketOverhead].

In block 17 method 20 derives a burstiness measure. This may comprise performing a Hurst parameter estimation procedure using the data collected in block 16. Block 17 returns a Hurst parameter value to the variable Hₑₛₜ for sampling period, i. The Hurst parameter estimation procedure of block 17 may proceed in any suitable manner now known or discovered in the future. For example, Hₑₛₜ may be computed by any of several techniques known to the art and described in the references cited above. One such estimation procedure is described in Abry, P. et al. Wavelet Analysis of Long-Range-Dependent Traffic, IEEE Trans on Information Theory; 44(1) (1998): 2-15, which is incorporated herein by reference. It will be appreciated that other parameters may be used as an estimate of the burstiness of traffic on link 6. One such parameter is described in Feldmann, A. et al. Data networks as cascades: Investigating the multifractal nature of Internet WAN traffic, Computer Communications Review, 28(4) (1998) 42-55.

In block 18 of FIG. 4, the utilization of the first link 6 is calculated. This may be done by summing the number of bits carried by link 6 over a suitable time interval and dividing by a capacity of link 6. For example, a variable SumOct may be initialized to 0 and then the sum of all of the Blocksize values of \vec{D}_{octet}(t) added to SumOct. This causes SumOct to hold a value which is the total number of octets received by detection device 5 on first link 6 over all Blocksize samples. A link utilization variable, Uᵥₐₗ, for first link 6 in sampling period, I, can be computed in the manner given by equation (1):

$${U}_{val} = \frac{( SumOct \times 8 ) \times 100}{ud} \qquad ( 1 )$$

Method 20 repeats the acquisition of data and the computation of a burstiness measure Hₑₛₜ and a utilization measure Uᵥₐₗ until it has accumulated a desired number of such values in vectors \vec{U} and \vec{H}. As shown in FIG. 4, at block 19, if the sampling period index, I, is less than or equal to the window size for vectors \vec{U} and \vec{H}, a branch to block 22 is made and the computed Uval and Hₑₛₜ are respectively stored in the i^{th} cells of vectors \vec{U} and \vec{H}. Method 20 then compares the value of the index, I, to N at block 25. If block 25 determines that I=N (which indicates that the total number of sampling periods for method 20 has been reached) then method 20 tests for a change of mode from “monitor” to “off” is done at step 26. If block 26 determines that mode has been set to “off” then method 20 terminates at block 27. Otherwise method 20 continues at block 15.

If block 19 determines that I is equal to winsize then method 20 proceeds to block 21 where the sample period values in vectors \vec{U} and \vec{H} are each shifted by one cell position to the next lower index value. For example, data in cell 2 is moved to cell 1, overwriting the previous value and data in cell 3 is moved to cell 2, etc. until the last cells at index value winsize, receive the latest computed values for Uᵥₐₗ and Hₑₛₜ.

Block 23 computes updated values for the mean burstiness measure and the mean utilization. These calculations may be performed as follows, or in any mathematically equivalent manner:

$$\begin{matrix}\overline{{U}_{past}} = \frac{{\sum }_{r = 1}^{K} U ( r )}{K} & ( 2 ) \\ \overline{{H}_{past}} = \frac{{\sum }_{r = 1}^{K} H ( r )}{K} & ( 3 ) \\ \overline{{U}_{present}} = \frac{{\sum }_{r = 1}^{K} U ( r + K + M )}{L} & ( 4 ) \\ \overline{{H}_{present}} = \frac{{\sum }_{r = 1}^{K} H ( r + K + M )}{L} & ( 5 )\end{matrix}$$

After method 20 computes these mean values in block 23, the mean values are tested in block 24 to determine if packet flooding is occurring. The block 24 tests to determine whether the mean utilization of link 6 has increased more than a first threshold amount, the burstiness parameter has decreased by more than a second threshold amount, and the burstiness parameter is less than a third threshold amount. If so then a packet flooding condition is indicated. These tests may be performed by evaluating the conditions of Equations (6) and (7).

(\overline{U}ₚᵣₑₛₑₙₜ−\overline{U}ₚₐₛₜ)>ΔU (6)

(\overline{H}ₚₐₛₜ−\overline{H}ₚᵣₑₛₑₙₜ)>ΔH and \overline{H}ₚᵣₑₛₑₙₜ<H_{flood} (7)

In another example, the tests may be performed by evaluating the conditions of Equations (8) and (9).

\overline{U}ₚᵣₑₛₑₙₜ>Threshold (8)

\overline{H}ₚᵣₑₛₑₙₜ<H_{flood} (9)

If both of the conditions of Equations (6) and (7) (or Equations (8) and (9)) are true then method 20 triggers an alarm signal in block 28. This may be done, for example, by setting a logical value PacketFloodAlarm to have a logical value of TRUE.

Method 20 may take various actions in response to determining that a packet flooding condition exists on link 6. For example, method 20 may include sending information identifying link 6 to a network management system which controls all or part of network 1. In addition, method 20 may provide for other actions such as:

causing detection device 5 to disable link 6;

reducing the bandwidth of link 6;

generating an audible or visual warning signal;

applying a packet filtering rule;

generating a message to a user or administrator; or the like.

If one of the conditions of equations (6) and (7) is not true then method 20 continues at block 25 which is described above.

Those skilled in the art will readily see that alterations and modifications to this particular embodiment are apparent. For example, detection device 5 may have first link 6 connected to a mirroring switch port on a network switch or router located within network 1, thereby monitoring the duplicated packet counts and octet counts for various selected ports, in sequence or as specified by the network management staff, for the network switch or router. In another embodiment, detection device 5 is incorporated within a network RMON probe device or network protocol analyzer which is attached to a network switch or router. In another embodiment, once a packet flood condition is detected, the system may trigger an alarm condition to the network to notify the network of the flood condition. The network itself may then execute for further actions against the packet flood condition.

Those skilled in the art will understand that the methods described herein permit abnormal traffic patterns, which indicate packet flood attacks to be distinguished from high volumes of normal traffic. There are several advantages that may be achieved in specific embodiments of system, method and apparatus of the invention. These include:

Detection device 5 can be independent of the hardware and software comprising client computer 4 or server computers 3. In such cases no unexpected or undesirable interactions between the client or server computer hardware or software systems are likely to result

Detection device 5 does not need to examine the contents of packets as they traverse links 6 and 7, but only needs to gather very basic packet traffic statistics. Therefore, the privacy and security of the client computer and server computer data are maintained.

The cost of the components used to construct the detection device 5 continue to decrease, thereby making the detection device 5 a cost-effective solution to the threat posed by packet flood denial of service attacks.

A packet flood on the first link can be detected with no changes necessary to the routing or switching process or knowledge of the upper layer protocols being used to transmit packets over the first link.

Apparatus according to the invention can be made to work with a fixed amount of memory and CPU resources are irrespective of the number of connections or attack sources present.

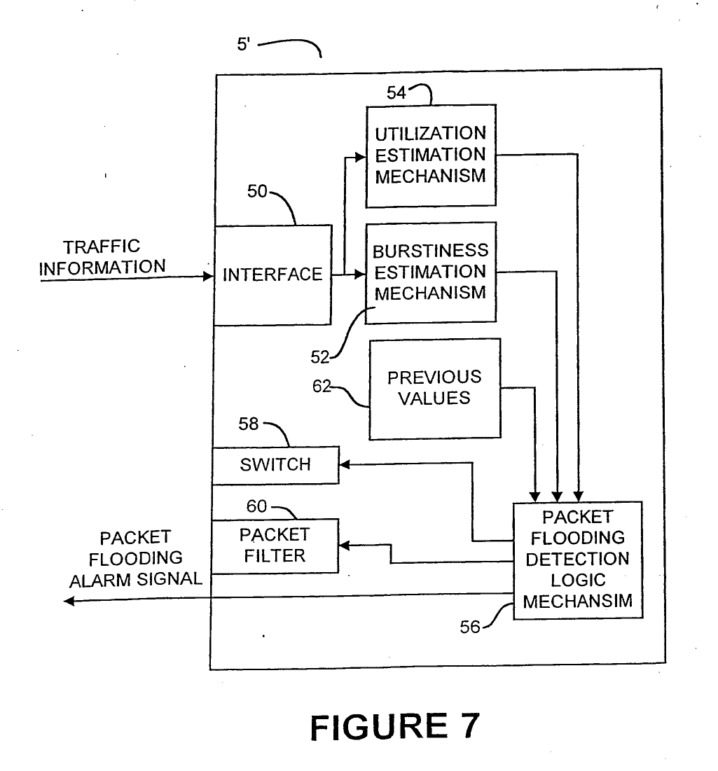

FIG. 7 shows a packet flooding detector 5′ according to an embodiment of the invention. Packet flooding detector 5′ comprises an interface 50 for receiving information about data traffic at a point in a network being monitored. Interface 50 provides, the information to a burstiness estimation mechanism 52 and a utilization estimation mechanism 54. Outputs of the burstiness estimation mechanism and the utilization estimation mechanism are connected to a packet flooding detection logic mechanism 56. Packet flooding detection logic mechanism 56 can be configured to do one or more of the following in response to the burstiness estimation mechanism and the utilization estimation mechanism producing outputs which satisfy a logic condition indicating packet flooding:

control a switch 58 which may be connected to cut off or restrict data flow in a link in which packet flooding traffic has been detected;

generate an alarm condition;

send a message or other signal indicating that packet flooding traffic has been detected on a link to a network controller. The signal may identify the affected link;

control a packet filtering system 60 to apply a filtering rule to data traffic flowing on an affected link.

In some embodiments of the invention burstiness estimation mechanism 52 comprises software running on a data processor which computes a burstiness measure from information received at interface 50 according to an algorithm specified by the software instructions. In other embodiments of the invention the burstiness estimation mechanism comprises hardware configured to calculate the burstiness measure. In certain embodiments the burstiness estimation mechanism may comprise a neural network which takes as inputs numbers of packets on the data link in a number of time intervals and produces as an output a burstiness measure.

Packet flooding detector 5′ optionally provides as inputs to packet flooding detection logic mechanism 56 one or more previous values 60 for the burstiness measure and/or utilization measure. These may be values which have been stored in a data store 62; values calculated by burstiness estimation mechanism 52 and utilization estimation mechanism 54; or values calculated by an additional separate burstiness estimation mechanism 52 and/or utilization estimation mechanism 54.

Burstiness estimation mechanism 52, utilization estimation mechanism 54 and packet flooding detection logic mechanism 56 may each comprise a software module, a component of a larger software program, a hardware module or the like.

While FIGS. 2 and 7 depict detection devices 5 and 5′ as stand-alone devices, the functions of detection devices 5 (or 5′) may be incorporated into other networked devices such as cable modems, DSL modems, Ethernet switches, routers, ATM switches and so on. The wide-spread use of the invention would reduce the impact of packet flood denial of service attacks by mitigating these attacks at the earliest stages, and, as well providing critical attack source identification information to network management staff such that compromised systems could be quickly located and secured against future compromise.

The system, method and apparatus of the embodiment overcomes the current inadequacy of existing detection systems in identifying a link which carries packet flooding traffic. One of the principle difficulties in prior art is that high levels of link utilization can be common for normal traffic patterns. However, disabling a link when utilization is high because it is believed that malicious packet flooding is occurring would lead to significant disruptions of legitimate network activity. The use of a burstiness parameter, such as a Hurst parameter estimate, in conjunction with utilization measures in the present invention provides a method for distinguishing abnormal traffic patterns and utilization patterns from normal network traffic.

As described above, preferred implementations of the invention comprise one or more computer processors executing software instructions which cause the computer processors to perform a method of the invention. The invention may also be provided in the form of a program product. The program product may comprise any medium which carries a set of computer-readable signals containing instructions which, when executed by a computer processor, cause the computer processor to perform a method of the invention. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links.

As will be apparent to those skilled in the art in the light of the foregoing disclosure, many alterations and modifications are possible in the practice of this invention without departing from the spirit or scope thereof. For example:

any of various parameters may be used to represent the burstiness of traffic on a link or other portion of the network being monitored. Where a Hurst parameter is used, Hurst-parameter estimators such as wavelet-based estimators, the Abry-Veitch estimator, or the like my be used.

The foregoing description is of a system which includes significant software components which run on one or more programmable processors. The system may also be implemented in hardware. Those skilled in the art of designing network devices, especially for high speed networks readily understand how to construct hardware circuits using ASICs of FPGAs, for example, which perform functions equivalent to functions performed by a programmable processor under software control.

Such alterations, modifications, and improvements are intended to be part of this disclosure, and are intended to be within the scope of the intention. Accordingly, the scope of the invention is to be construed in accordance with the substance defined by the following claims.

1. A method for detecting packet flooding in a communication network, comprising a data link carrying data traffic, the method comprising:
obtaining characteristics of the data traffic; and,
detecting packet flooding by analyzing the characteristics.

2. The method of claim 1 wherein the characteristics comprise a burstiness characteristic and analyzing the characteristics comprises comparing the burstiness characteristic to a burstiness threshold.

3. The method of claim 2 wherein the characteristics comprise a utilization and analyzing the characteristics comprises comparing the utilization to a utilization threshold.

4. The method of claim 1 wherein detecting packet flooding comprises determining that a burstiness characteristic of the data traffic is lower than an expected burstiness of normal data traffic.

5. The method of claim 4 wherein detecting packet flooding comprises determining that a utilization of the data traffic is higher than a threshold.

6. The method of claim 4 wherein detecting packet flooding comprises determining that a rate of increase of the utilization is greater than a utilization increase threshold.

7. The method of claim 4 wherein detecting packet flooding comprises determining that a rate of decrease of the burstiness characteristic is greater than a burstiness decrease threshold.

8. The method of claim 7 further comprising computing the rate of decrease of the burstiness characteristic by comparing the burstiness characteristic measured in a first window to the burstiness characteristic measured in a second window.

9. The method of claim 8 wherein an end time of the first window is separated from a start time of the second window by an interval in the range of 0 to 600 seconds.

10. The method of claim 2 wherein obtaining characteristics of the data traffic comprises computing an estimate of a Hurst parameter for the data traffic and the burstiness characteristic comprises the estimate of the Hurst parameter.

11. The method of claim 2 wherein obtaining characteristics of the data traffic comprises recording a number of data packets received on the data link for each of a plurality of time intervals.

12. The method of claim 11 wherein obtaining characteristics of the data traffic comprises recording a volume of data received on the data link during each of the plurality of time intervals.

13. The method of claim 11 wherein each of the time intervals has a length sufficient to sample 10⁵ bits at the bandwidth of the link.

14. The method of claim 11 wherein analyzing the characteristics comprises performing a wavelet transformation on the numbers of data packets received on the data link for the plurality of time intervals.

15. The method of claim 11 wherein analyzing the characteristics comprises providing the numbers of data packets received on the data link for the plurality of time intervals as inputs to a neural network.

16. The method of claim 2 wherein said characteristics correlate to a Hurst parameter.

17. The method of claim 1 further comprising:
responding to detecting packet flooding by terminating a connection associated with the data traffic.

18. The method of claim 1 further comprising:
responding to detecting packet flooding by generating an alarm signal.

19. The method of claim 1 further comprising:
responding to detecting packet flooding by applying a filter to the data traffic.

20. The method of claim 1 further comprising:
responding to detecting packet flooding by reducing a bandwidth of the link.

21. The method of claim 1 wherein obtaining characteristics of the data traffic comprises reading statistics regarding the data traffic maintained by a network device connected to the link.

22. The method of claim 1 wherein obtaining characteristics of the data traffic comprises collecting statistics regarding the data traffic at a network device and transmitting the statistics to a detection device.

23. A system for detecting packet flooding in a communication network, comprising a data link carrying data traffic, the system comprising:
an interface for receiving information about the data traffic;
an analysis mechanism configured to provide a measure of burstiness in the data traffic from the information; and,
is a packet flooding detection mechanism configured to signal a packet flooding condition based at least in part on the measure of burstiness.

24. The system of claim 23 wherein the analysis mechanism comprises a data processor executing software instructions which cause the data processor compute the measure of burstiness based upon the information.

25. The method of claim 24 wherein the information about the data traffic comprises a number of packets on the link in each of a plurality of intervals, the apparatus comprises a data structure holding the numbers of packets as elements in an array, and the analysis mechanism is configured to compute the burstiness measure based upon a subset of the elements in the array corresponding to a time window.

26. The method of claim 25 wherein the analysis mechanism comprises a data store holding a burstiness measure for a previous time window and the apparatus comprises a mechanism for comparing the burstiness measure for the previous time window to a burstiness measure for a current time window.

27. The system of claim 23 wherein the interface and analysis mechanism are integrated in a packet handling device.

28. The system of claim 24 wherein the measure of burstiness comprises a Hurst parameter.

29. The system of claim 24 wherein the information comprises statistics regarding a number of packets in the data traffic in each of a plurality of time periods, the measure of burstiness is based upon a wavelet transform of the information, and the analysis mechanism comprises means for computing a wavelet transform of the information.

30. The system of claim 29 further comprising a neural network configured to accept as inputs information about the data traffic and to produce the measure of burstiness as an output.

31. The system of claim 23 further comprising means for terminating a communication link, responsive to a signal that the packet flooding detection mechanism has detected a packet flooding condition.

32. The system of claim 23 further comprising means for generating an alarm condition, responsive to a signal that the packet flooding detection mechanism has detected a packet flooding condition.

33. The system of claim 23 further comprising means for filtering the data traffic responsive to a signal that the packet flooding detection mechanism has detected a packet flooding condition.

34. The system of claim 23 further comprising a switch connected to terminate a communication link carrying the data traffic, the switch responsive to detection of a packet flooding condition by the packet flooding detection mechanism.

35. Apparatus for detecting packet flooding on a data communication network, the apparatus comprising:
an interface for receiving information about data traffic at a point in a network being monitored;
a burstiness estimation mechanism connected to receive information from the interface;
a utilization estimation mechanism connected to receive information from the interface; and,
a packet flooding detection logic mechanism connected to receive information output by the burstiness estimation mechanism and the utilization estimation mechanism.

36. The apparatus of claim 35 further comprising a switch operable to cut off or restrict data flow in a link in which packet flooding traffic has been detected in response to an output from the packet flooding detection logic mechanism.

37. The apparatus of claim 35 further comprising a packet filter operable to apply a filtering rule to data traffic flowing on an affected link in response to an output from the packet flooding detection logic mechanism.

38. A program product comprising a medium carrying a set of computer-readable signals containing instructions which, when executed by a computer processor, cause the computer processor to perform the method of claim 1.
